(19) United States
(12) Patent Application Publication
(10) Pub. No.: US 2017/0127171 A1
(43) Pub. Date: May 4, 2017

(54) NOISE REDUCTION SYSTEM

(71) Applicant: SOUNDCHIP SA, Bussigny-pres-Lausanne (CH)

(72) Inventor: Thomas John Haworth, Manchester (GB)

(21) Appl. No.: 15/335,810

(22) Filed: Oct. 27, 2016

(30) Foreign Application Priority Data
Oct. 30, 2015 (GB) 1519219.8

(51) Int. Cl. H04R 1/10; H04R 3/06; H04R 19/04

(52) U.S. Cl. CPC H04R 1/1083; H04R 19/04; H04R 3/06; H04R 2460/01

(57) ABSTRACT

Earphone apparatus includes at least one earphone driver operative to receive an input signal and mounted so as to deliver sound to a wearer's ear, and a sensing microphone sensitive to noise around the wearer's head but substantially insensitive to the sound generated by the at least one earphone driver. The earphone apparatus is configured to co-act with an existing remote noise cancellation device, the existing remote noise cancellation device being originally intended for the provision of feedback active control, to enable operation in a feed-forward configuration to effect noise reduction in sound delivered by the at least one earphone driver.

### CROSS-REFERENCE TO RELATED APPLICATION

This application claims the benefit of U.K. application GB 1519219.8 filed Oct. 30, 2015, the entire disclosure of which is hereby expressly incorporated by reference.

### BACKGROUND OF THE DISCLOSURE

Field of the Disclosure

This disclosure relates to active noise reduction systems and particularly but not exclusively to earphone apparatus for use in an active noise reduction system (e.g. in an In-Flight Entertainment and Communications (IFEC) system).

Brief Description of Related Technology

Earphones (e.g. circumaural or supra-aural earphones of the type connected together by a headband to form headphones or in-ear/in-the-canal earphones configured to be placed at the entrance to or in the auditory canal of a user's ear) provided with active noise cancelling capability are well known in the art. Typically such active technology is integral to the earphone. It is also known to provide earphones with active noise cancelling functionality wherein the earphone integrates only the transducers and actuators necessary to effect such cancellation but where the electronics are remotely located from the earphone. U.S. Pat. No. 7,489,785 B2 (the entire contents of which are hereby incorporated by reference) teaches how the earphone of such a system may incorporate a simple, passive filter provided to ensure stable and successful operation with a standardized remote electronics, despite variability in the design of the earphone and the electro-acoustic sub-assembly there formed.

It is central to the conception, design and implementation of these active noise cancellation systems that they are intended to be operated in “feedback” configuration. This configuration, which is a canonical architecture well understood in the art of automatic control, is reflected in i) the construction of headphone types intended to be operated with such systems and ii) the nature of the control system or compensator integral to the remote electronics.

### SUMMARY OF THE DISCLOSURE

In accordance with a first aspect, there is provided an earphone apparatus including at least one earphone driver operative to receive an input signal and mounted so as to deliver sound to a wearer's ear, and a sensing microphone sensitive to noise around the wearer's head but substantially insensitive to the sound generated by the at least one earphone driver (e.g. external sensing microphone). The earphone apparatus is configured to co-act with an existing remote noise cancellation device, the existing remote noise cancellation device being originally intended for the provision of feedback active control, to enable operation (e.g. of the composite system formed by the earphone apparatus and existing remote noise cancellation device) in a feed-forward configuration to effect noise reduction in sound delivered by the at least one earphone driver.

In this way, a reinterpretation of the use of extant remote electronic sub-assemblies intended for feedback control is provided to furnish those earphones suitably equipped with transducers (e.g. sensing microphone) and actuators (e.g. earphone driver), to deliver robust and improved active noise cancellation. Modifications in the design of the earphones and integrated transducer are also described to support this reinterpretation.

According to one aspect, the system is reinterpreted to operate in “feed-forward” configuration. This configuration, again well understood in the art of automatic control and particularly well-rehearsed in the provision of earphones with active noise cancelling capability, constitutes a radical re-interpretation of the remote electronic infrastructure already provided to support active noise cancellation in (e.g.) passenger aircraft. In such application, the remote electronics are provided in the passenger seat. The compensation provided by these existing remote noise cancellation devices (hereinafter referred to as “remote electronic sub-assemblies”) has been designed with reference only to a feedback control application, as is demonstrated by the provision of functionality required only in the case of feedback operation.

According to a further aspect, an earphone assembly is provided with an integrated miniature loudspeaker (“receiver”), or multiplicity thereof, and a sound transducer (usually a microphone), capable of cooperation with the remote electronic sub-assemblies provided to enable active noise cancellation. However, earphone assemblies as described herein place the sound transducer external to the body of the earphone, where it is insensitive to the sound generated by the receiver, but sensible only to the pressures around the head of the wearer. This sensor placement immediately confers a “feed-forward” control architecture, which dramatically removes the risk of system instability that limits and frustrates the successful operation of active noise control systems constructed according to the “feedback” architecture. It also has been found to enable levels of performance which exceed that possible in the originally intended “feedback” control paradigm.

According to a further aspect, the earphone assembly is optionally provided with a filter network, which operates upon the signal detected by the (externally sensible) microphone. This filter network may include active elements, powered by the voltage source manifest in extant remote electronic sub-assemblies (intended for powering the microphone). This filter network may alternatively include only passive elements, requiring no power supply. The filter network is operative so as to assist in providing appropriate gain and phase response to furnish successful feed-forward noise control in the composite system. This is distinct from the control of phase response alone, for feedback applications, as taught in U.S. Pat. No. 7,489,785 B2.

According to a still further aspect, an earphone assembly is optionally provided with a second filter network, which operates upon the signal generated by the control system in the remote electronic sub-assembly before it is passed to the receiver. This second filter network may simply be operative to further collaborate in furnishing successful feed-forward noise control. However, it is a desirable feature of feedback noise controllers that any incoming electronic audio signal (such as music or other entertainment sources or down-link signals in telephony) is pre-filtered or compensated to account for the damaging effects that the (feedback) noise cancelling system will impose upon the audio signal's spectral balance. This desirable feature is implemented in some of the remote electronic sub-assemblies found (e.g.) in aircraft seats, with which the present assembly is intended to co-operate. Accordingly, the second filter network is configured to “undo” (in whole or in part) any pre-filtering or compensation of the audio signal provided by the remote electronics, thereby securing a more satisfactory audio response. It is then the dual function of the second filter network to i) provide restoration of the intended audio signal's spectral balance AND ii) to furnish successful feed-forward noise control in the composite system.

According to yet a further aspect, the headphone assembly incorporative of the features described above is designed (according to electro-acoustic principles understood in the art) to provide appropriate acoustic and electro-acoustic behaviour. This behaviour is designed to offer not only a performance amenable to the application of feed-forward control but also a performance amenable to co-operation with the extant control systems in remote electronic sub-assemblies, such as to provide robust, useful control of noise AND acceptable audio performance. Such behaviour is delivered by the management of i) noise transmission over the earphone and ii) the receiving electro-acoustics of the earphone. The former controls the relationship between the external pressure and the noise that is transmitted to the ear. The latter controls not only the reproduction of audio but also the production of the active control pressures. Since parameters of the earphone assembly appear in the controlling equations defining the active noise control and audio response, careful design of the earphone apparatus—e.g. careful control of the gain and phase of the transfer functions of the noise transmission and receiving response—may significantly improve feedforward performance of the composite system.

In accordance with a second aspect there is provided a noise cancellation system including earphone apparatus according to the first aspect, and an existing remote noise cancellation device originally configured for the provision of feedback active control. The earphone apparatus co-acts with the existing remote noise cancellation device to enable operation in a feed-forward configuration to effect noise reduction in sound delivered by the at least one earphone driver.

In one embodiment, the existing remote noise cancellation device is optimised for the delivery of feed-forward control.

In accordance with a third aspect there is provided a method of upgrading an (e.g. IFEC) noise cancellation system including at least one existing remote noise cancellation devices originally configured for the provision of feedback active control when used with an existing feedback earphone, the method including providing earphone apparatus according to the first aspect and connecting the earphone apparatus to the at least one existing remote noise cancellation device, whereby the earphone apparatus co-acts with the at least one existing remote noise cancellation device to enable operation in a feed-forward configuration to effect noise reduction in sound delivered by the at least one earphone driver.

Contemporary deployment and exploitation of active noise control systems with the distributed architecture of an earphone with integrated transducers, actuators and simple filters and a remotely located electronic sub-assembly is most typical in passenger aircraft. Whilst this is one application, there is no reason why the methods taught herein should not find useful application in other cases where it is desired to provide head-worn active noise control. These may include not only other transport applications (such as trains or other passenger vehicles) but also personal audio products (such as audio players and various species of computing and communicating devices).

### BRIEF DESCRIPTION OF THE DRAWING FIGURES

FIG. 1 shows the prior art composite noise control system.

FIG. 2 shows a simple realisation of the prior art system's passive filter, as taught in U.S. Pat. No. 7,489,785 B2.

FIG. 3 shows the prior art application of the noise cancellation system.

FIG. 4 shows an equivalent block diagram of the prior art system, revealing and emphasizing the recursive, “feedback” architecture.

FIG. 5 shows the configuration of an earphone apparatus with a new headphone in accordance with one embodiment connected to the prior art remote electronic sub-assembly.

FIG. 6 shows an equivalent block diagram of an earphone apparatus in accordance with one embodiment, revealing and emphasizing the “feed-forward” architecture.

FIG. 7 shows the audio input to the remote electronic sub-assembly and apparatus to remove the effects of pre-filtering.

FIG. 8 shows an apparatus including an adjustable gain element for system configuration.

### DETAILED DESCRIPTION OF THE DISCLOSURE

A prior art system is shown in FIG. 1. This system includes two separate sub-assemblies, which, in concert, deliver personal active noise control to a wearer. A headphone or earphone, 101 is intended to be operative with a remotely located electronic sub-assembly 102. The two sub-assemblies, seen on either side of the vertical, dashed dividing line in FIG. 1, are plugged together by an appropriate connector in use, thereby completing the circuits required for operation.

The headphone includes a sound transducer, 103, usually implemented as a microphone, sensible to pressures, which will be used by the remote electronic sub-assembly 102 to design controlling signals. The teachings of U.S. Pat. No. 7,489,785 B2 explain how the provision of a simple network 104, having transfer function N₁ may render a wide range of headphones, 101, having differing acoustics and electro-acoustics, to be operative with a single, standardized remote electronic sub-assembly, 102.

The headphone further includes a miniature loudspeaker (known in this application as a “receiver”), 105. The receiver functions so as to turn the control voltages, designed by the remote electronic sub-assembly, into the controlling pressures, necessary to provide active noise control. Although not shown in FIG. 1, the receiver may further function to reproduce music or communication signals. This further function is elaborated in subsequent description.

The remote electronic sub-assembly includes a power source, consisting of a voltage source 106 and a “bias” resistor 107, intended to power a microphone 103 in the headphone assembly. The microphone is usually embodied in an electret condenser technology. The signal component of the voltage generated at the microphone output is separated from the (d.c.) power supply by the blocking capacitor 108. This signal component is then passed to an amplifier, 109, which imposes a transfer function A₁ upon the microphone signal. This amplifier provides gain and may optionally provide signal conditioning and other non-trivial aspects of processing. The remote electronic sub-assembly further incorporates a control filter, 110, having frequency response C. This network provides the main elements of the processing required in the design of the cancelling signal. It is of primarily a low-pass characteristic, reflecting the fact that the extant remote electronic sub-assembly is designed to support a feedback noise control strategy, which is operative over only a range of low frequencies. The remote electronic sub-assembly also includes a power amplifier stage, 111, having response described by A₂. This is provided principally to drive the receiver, which requires a power input to drive its (generally) low impedance and generate sound. Other details of the remote electronic sub-assembly 102, including the detection of the presence of an appropriately equipped headphone (as opposed to a conventional headphone without an integrated microphone) are of no importance to the present disclosure and are not further discussed.

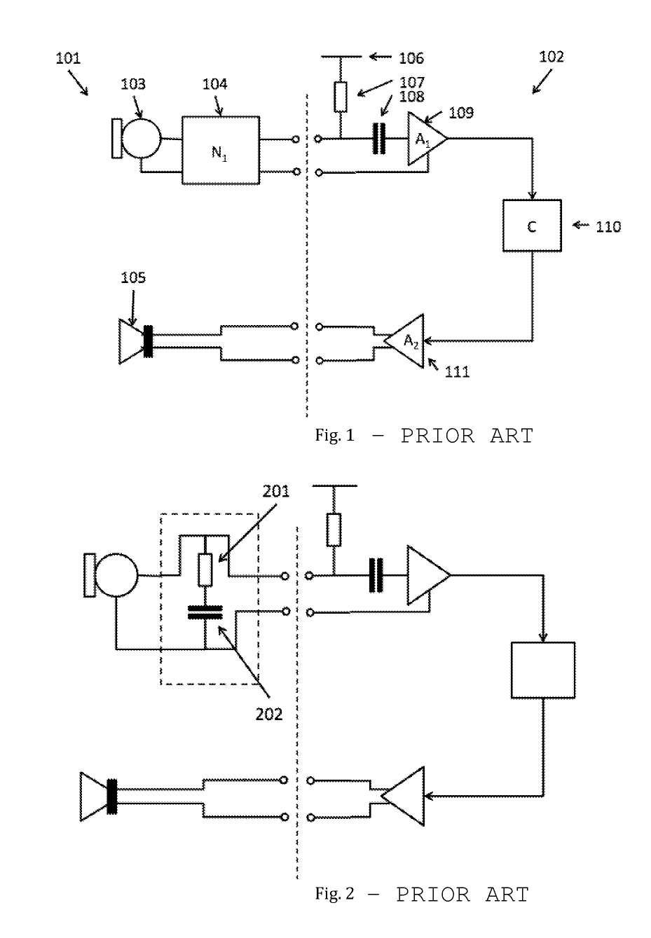

U.S. Pat. No. 7,489,785 B2 has taught that the network N₁ may be implemented as a simple passive network. This configuration is shown in FIG. 2, where the specific example of a series combination of a single resistor 201 and single capacitor 202, shunting the microphone output terminals, is seen.

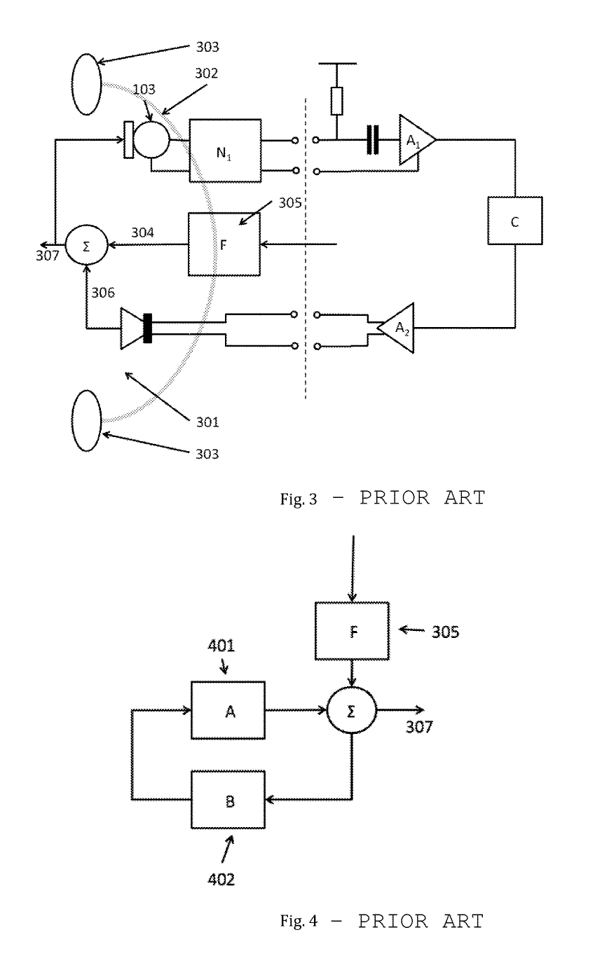

In use, the system of FIGS. 1 & 2 is deployed in a headphone with the microphone placed such that it is sensible to the pressures INSIDE the volume of air 301 enclosed by the shell or body of the headphone, 302, as seen in FIG. 3. The enclosed volume of air is further sealed from the pressures outside the unit by the cushion or pad, 303, which seals against the wearer's head. The pressure inside the headphone is comprised of three components. The first component is the noise pressure, 304, that has been transmitted through the headphone by transmission (and around it by flanking) via an overall transfer function 305 denoted by F. The second component, 306, is the cancelling pressure generated by the receiver. The sum of the noise component and the cancelling pressure is the residual, 307, heard by the ear. There is a third component not seen in FIG. 3: the pressure generated by the receiver associated with any audio signal. This third component is omitted from the early figures for clarity, but will be considered. These pressure components sum before detection at the microphone, 103, of the prior art implementation shown in FIG. 3.

The system of FIG. 3 can be represented by the simplified block diagram shown as FIG. 4, in which the components of the forward receiving response are gathered into one block, 401, having transfer function A. The forward transfer function includes the second amplifier, 111, the receiver response and the forward internal acoustics. Another block, 402, having transfer function B, represents the microphone response, the response of any intermediate network 104, the blocking capacitor network, 108, the first amplifier 109 and the controller, 110. The noise element enters the system via the transfer function F, already defined, 305.

Action of the prior art noise canceller of FIG. 4 is well understood by those familiar with active noise control to introduce a scaling to the noise ingress into the headphone, described by the ratio

$$\frac{F}{1 - AB} \qquad [ 1 ]$$

The design task is to set those aspects of A and B accessible to the system designer (i.e. those in the headphone—the remote electronic sub-assembly being defined a priori) so as to minimise the ratio, whilst obeying the requirements of system stability. In practice, this amounts to transducer selection, headphone design and—particularly—the design of N₁ (which forms a factor of A) to establish a high loop gain |AB|>>1, whilst observing the demand for system stability arising from well-rehearsed criteria.

The topology of FIG. 4 and the associated active noise reduction of the ratio [1] will be recognised by skilled practitioners as characteristic of a feedback noise controller. The instances of this type of noise controlling headphone as described by U.S. Pat. No. 7,489,785 B2 are all of this type.

This is a prerequisite of U.S. Pat. No. 7,489,785 B2, which teaches “at least one sound transducer provided in the headset adjacent to the Speaker”. Specifying the sound transducer to be “adjacent to the Speaker” is important as such adjacency ensures the microphone is sensible to the receiver pressure, which, in turn, imposes the feedback architecture.

The provision of audio pre-filtering or compensation, where fitted, to counteract the modification of the audio signal by the control system, is further evidence of the intentional provision of extant remote electronic sub-assemblies to support feedback noise cancellation, as no such pre-filtering is required in feed-forward systems. This is discussed below.

Further, all known instances and embodiments of personal noise cancelling systems with headphone and remote electronic sub-assembly, according to U.S. Pat. No. 7,489,785 B2, have used the feedback configuration.

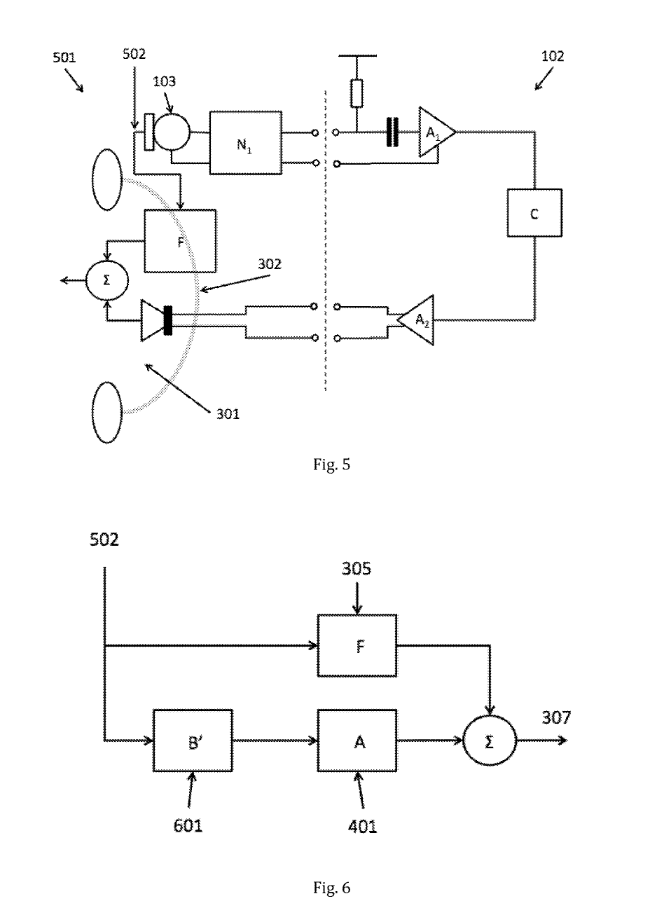

The present disclosure reinterprets FIG. 1 in use, to the alternative configuration depicted in FIG. 5, in which a new headphone, 501, is constructed with the microphone, 103, placed such that it is sensible to the pressures, 502, OUTSIDE the volume of air, 301, enclosed by the shell or body of the headphone, 302. This renders the feedback path that is the origin of potential instability (in cases of poor design, inappropriate use or system malfunction) non-existent. It also changes the control architecture to a feed-forward paradigm, as described below.

The block diagram equivalent of FIG. 5 is presented as FIG. 6, in which the pressures outside the headphone, 502, that both i) excite the noise transmission path F and ii) provide the signal for design of the controlling pressure appear at the input on the left side of the figure. The forward path 401 is familiar from previous Figures, but the controller, 601, now is designed so as to minimize the residual noise audible to the wearer by seeking to force the equality:

F=−AB′ [2]

Skilled practitioners will recognize this as a feed-forward control architecture. The design task is now to seek to make controllable elements of the system such as to satisfy [2] by transducer selection, headphone design and the design of N1.

Note that all elements of the remote electronic sub-assembly, 102, are fixed and are common to the applications associated with [1] and [2]. However, the desiderata of the prior art interpretation and the present disclosure are very different, demanding different acoustic, electro-acoustic and electronic designs to deliver [1] and [2]. The peak gain of the electronic controlled implied by [2] is very much smaller than that associated with the provision of active noise control through [1]. In the former, the peak value of the controller gain is of order unity, max(|AB′|)˜1. In the latter the peak loop gain is of order ten, max(|AB|)˜10. This demonstrates that the removal of the risk of instability is achieved not only by re-positioning of the microphone but also by reduction of the controller gain.

The embodiments of the remote electronic sub-assembly include an audio input, 701, by which program material associated with entertainment or communication etc. may be passed to the wearer for reproduction in the headphone. This is seen in FIG. 7, in which there is also an explicit filter block, 702, provided to pre-filter or compensate the audio signal with the transfer function P. Without this filter, the noise cancelling, expressed in [1], would also be impressed as a filtering operation on the audio in the standard prior-art embodiment. Unfortunately, current some current embodiments of the remote electronic sub-assembly, 102, include this pre-filtering, whilst others do not.

The present disclosure includes the option of providing a second filter network, 703, having transfer function N₂, between the amplifier of the remote electronic sub-assembly and the receiver. In the presence of the pre-filtering, 702, N₂ may be designed to approximate in whole or in part the ratio [1], as the pre-filtering would itself implement in whole or in part the inverse of this ratio. However, N₂ must also be considered as a factor in the feed-forward controller design.

Grouping the fixed elements of the remote electronic sub-assembly 102 together and leaving those aspects of the disclosure under the control of the application designer, the overall noise reduction is described by the control task of forcing the control path to model the negative of the noise transmission path [2], which is:

$$[ {N}_{1} {N}_{2} ML ] \approx \frac{- \{ {A}_{1} {CA}_{2} \}}{[ F ]} \qquad [ 3 ]$$

The controllable aspects of the application are grouped in the square brackets, whilst those elements defined a priori by the extant remote electronic sub-assembly, 102, are in the curved brackets. The controllable elements are the two networks 104 and 703, the microphone sensitivity M, the receiving electro-acoustic response of the receiver, L and the noise transmission path, F.

In those cases where the remote electronic sub-assembly includes a pre-filter, P, the design task further includes the simultaneous approximation:

$${N}_{2} \approx \frac{1}{P} \qquad [ 4 ]$$

Designing a new application according to the present disclosure therefore consists in trying to force [3] as closely as possible to an equality and optionally (in the presence of pre-filtering, 702) handling [3] and [4] as a pair of simultaneous equations.

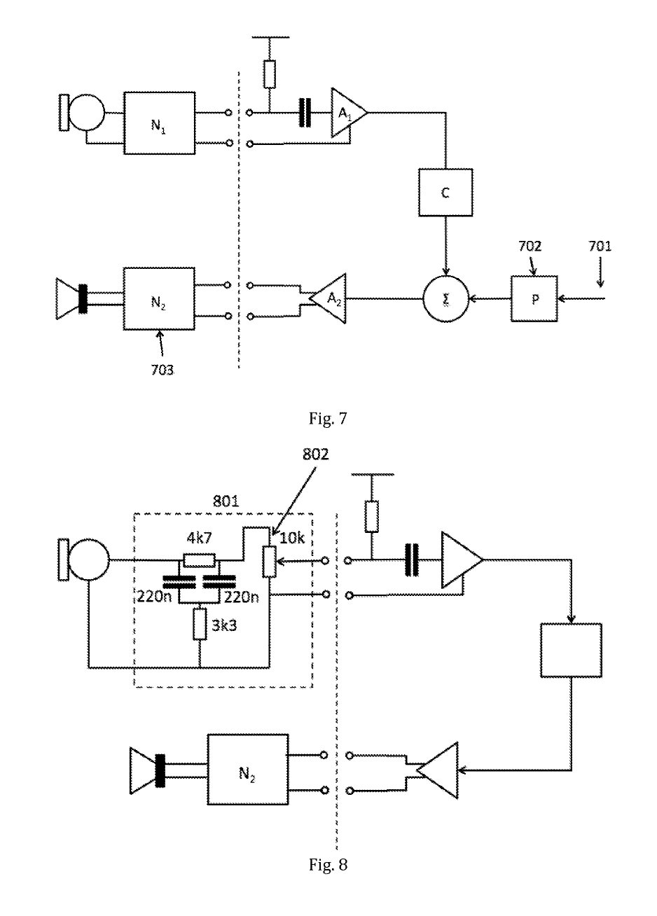

The successful deployment of feed-forward noise control depends critically upon the provision of an accurate gain and phase match between the two paths F and AB′ of FIG. 6. The phase response is secured by appropriate overall system design but the gain may require precise tuning on a unit-by-unit basis in order to correct for the inevitable production spread in the pressure sensitivity of the microphone. This is conveniently achieved in the network 104 by the provision of a trimmer potentiometer, which may the adjusted at manufacture to set the correct gain of the individual unit. One example, 801, of an implementation of the N₁ network, including the calibrating potentiometer, 802, is shown as FIG. 8. The gain adjustment means may advantageously be appropriate for automatic adjustment during a computer-aided, automated configuration step in the manufacturing process. This may be achieved, for example, by implementing the gain adjustment in a digital potentiometer.

In light of the teaching of this document, it becomes self evident that a new form of remote electronic sub-assembly, appropriate when used in concert with an appropriately equipped headphone for the delivery of feed-forward active noise control, could be produced. Such an appropriately equipped headphone is that described above. This new remote electronic sub-assembly would feature an alternative compensator, 110, appropriate for feed-forward applications.

What is claimed is:

1. Earphone apparatus comprising:
at least one earphone driver operative to receive an input signal and mounted so as to deliver sound to a wearer's ear; and
a sensing microphone sensitive to noise around the wearer's head but substantially insensitive to the sound generated by the at least one earphone driver;
wherein the earphone apparatus is configured to co-act with an existing remote noise cancellation device, the existing remote noise cancellation device being originally intended for the provision of feedback active control, to enable operation in a feed-forward configuration to effect noise reduction in sound delivered by the at least one earphone driver.

2. Earphone apparatus according to claim 1, further comprising at least one filter network operating on one or both of the input signal of the at least one earphone driver and an output of the sensing microphone.

3. Earphone apparatus according to claim 2, wherein the at least one filter network is configured so as to permit the earphone apparatus to co-act with the existing remote noise cancellation device to force the composite system to operate as a feedforward noise controller.

4. Earphone apparatus according to claim 1, wherein the acoustics and/or electro-acoustics of the earphone apparatus are designed so as to permit the earphone apparatus to co-act with the existing remote noise cancellation device to force the composite system to operate as a feedforward noise controller.

5. Earphone apparatus according to claim 1, wherein the sensing microphone is an electret condenser microphone or silicon microphone.

6. Earphone apparatus according to claim 1, further comprising a first filter network that is an active system.

7. Earphone apparatus according to claim 6, wherein the first filter network is powered by a microphone bias supply from the existing remote noise cancellation device.

8. Earphone apparatus according to claim 1, further comprising a first filter network that is a passive electrical network.

9. Earphone apparatus according to claim 8, wherein the first filter network includes a sensitivity adjuster to adjust the effective sensitivity of the sensing microphone.

10. Earphone apparatus according to claim 9, wherein the first filter network is operative to adjust the effective sensitivity of the sensing microphone to optimise the degree of feed-forward control provided by the composite system.

11. Earphone apparatus according to claim 9, wherein the first filter network includes a trimmer potentiometer to adjust the effective sensitivity of the sensing microphone.

12. Earphone apparatus according to claim 6, wherein the first filter network includes an automated sensitivity adjuster to automatically adjust the effective sensitivity of the sensing microphone in an automated manufacturing process.

13. Earphone apparatus according to claim 6, wherein the first filter network includes a digitally-controlled potentiometer to adjust the effective sensitivity of the sensing microphone.

14. Earphone apparatus according to claim 1, comprising a second filter network that operates on an amplifier output of the remote noise cancellation device before the amplifier output is applied to the at least one earphone driver to optimise the degree of feedforward control provided by the composite system.

15. Earphone apparatus according to claim 14, wherein the second filter network is an active filter network.

16. Earphone apparatus according to claim 15, wherein the second filter network is a passive filter network.

17. Earphone apparatus according to claim 14, wherein the second filter network is operative to permit the earphone apparatus to co-act with the existing remote noise cancellation device to force the composite system to operate as a feedforward noise controller.

18. Earphone apparatus according to claim 14, wherein the second filter network is operative to cancel in whole or in part effects of pre-filtering or compensating filters in the audio input of the remote noise cancellation device.

19. Earphone apparatus according to claim 14, wherein the second filter network has a response which includes a factor approximating the inverse of a response of any pre-filtering or compensating filters in the audio input of the remote noise cancellation device.

20. A noise cancellation system comprising:
earphone apparatus according to claim 1; and
an existing remote noise cancellation device originally configured for the provision of feedback active control;
wherein the earphone apparatus co-acts with the existing remote noise cancellation device to enable operation in a feed-forward configuration to effect noise reduction in sound delivered by the at least one earphone driver.

21. The noise cancellation system according to claim 20, wherein the existing remote noise cancellation device is optimised for the delivery of feed-forward control.

22. A method of upgrading an IFEC noise cancellation system comprising at least one existing remote noise cancellation devices originally configured for the provision of feedback active control when used with an existing feedback earphone, the method comprising:
providing earphone apparatus comprising:
at least one earphone driver operative to receive an input signal and mounted so as to deliver sound to a wearer's ear; and
a sensing microphone sensitive to noise around the wearer's head but substantially insensitive to the sound generated by the at least one earphone driver;
wherein the earphone apparatus is configured to co-act with an existing remote noise cancellation device, the existing remote noise cancellation device being originally intended for the provision of feedback active control, to enable operation in a feed-forward configuration to effect noise reduction in sound delivered by the at least one earphone driver; and
connecting the earphone apparatus to the at least one existing remote noise cancellation device, whereby the earphone apparatus co-acts with the at least one existing remote noise cancellation device to enable operation in a feed-forward configuration to effect noise reduction in sound delivered by the at least one earphone driver.
